(19) United States
(12) Patent Application Publication
(10) Pub. No.: US 2012/0268826 A1
(43) Pub. Date: Oct. 25, 2012

(54) LIGHT DIFFUSION SHEET, METHOD FOR MANUFACTURING SAME, AND TRANSMISSIVE DISPLAY DEVICE PROVIDED WITH LIGHT DIFFUSION SHEET

(75) Inventors: Tokiyoshi Umeda, Osaka-shi (JP); Emi Yamamoto, Osaka-shi (JP); Akinori Itoh, Osaka-shi (JP)

(73) Assignee: SHARP KABUSHIKI KAISHA, Osaka-shi, Osaka (JP)

(21) Appl. No.: 13/511,665

(22) PCT Filed: Dec. 2, 2010
(86) PCT No.: PCT/JP2010/071603

§ 371 Date: May 24, 2012

(30) Foreign Application Priority Data
Dec. 3, 2009 (JP) 2009-275524

(51) Int. Cl. G02B 5/02; B32B 38/10; B32B 37/14

(52) U.S. Cl. 359/599; 156/60; 156/247

(57) ABSTRACT

A light diffusion sheet (1) includes a lower base film (2), an upper base film (3), a light diffusing section (4), a plurality of light absorbing sections (5), and an adhesive layer (6). The light diffusing section (4), the plurality of light absorbing sections (5), and the adhesive layer (6) are provided between the lower base film (2) and the upper base film (3). Specifically, the light diffusing section (4) is provided on the lower base film (2). The light diffusing section (4) has formed a plurality of concave parts (8) therein. The upper base film (3) is provided on the light diffusing section (4). The plurality of light absorbing sections (5) fit in the plurality of respective concave parts (8) via respective gaps.

### TECHNICAL FIELD

The present invention relates to (i) a light diffusion sheet suitably used in a display device such as a liquid crystal display device, (ii) a method for manufacturing the light diffusion sheet and (iii) a display device provided with the light diffusion sheet.

### BACKGROUND ART

Recently, display devices have been remarkably developed and researched, thereby resulting in widespread use of display devices called thin flat panel displays (FPD) to replace cathode-ray tube display devices having been conventionally predominant. The FPD have varieties employing liquid crystal, a light emitting diode (LED) or an organic electroluminescence (EL) as their display elements.

Such a display device emits light to a display screen or emits light by use of, for example, a backlight provided in a backside of the display screen (a side opposite to an observer side). An observer observes light emitted from the display screen. Note that the display device is designed such that light obliquely emitted from the display screen can look in the same manner as does light emitted straightforwardly from the display screen. That is, the display device is designed such that the display screen looks with no difference between when viewing the display screen from an oblique direction and when viewing the display screen at the front of the display screen. However, the design is not sufficient. A contrast property of the display screen is excellent when the display screen is viewed at the front of the display screen. There is, however, a case where the display screen seems to have a greater contrast when viewed from the oblique direction than when viewed at the front of the display screen. That is, according to the display device, how display appears is dependent on a direction in which the display is observed. In other words, the display device is poor in viewing angle property.

In order to improve the viewing angle property of the display device, the following method has been developed. In order to cause the display screen to be viewable from an oblique direction, a sheet for diffusing light is provided over the display screen in the display device. Examples of the light diffusion sheet encompass a sheet processed to have a convexoconcave surface, and a sheet containing light diffusing particles inside thereof. The light diffusion sheet refracts or totally reflects light of a backlight in many directions by use of a difference in refractive index. The light refracted by the light diffusion sheet is diffused and emitted in many directions from a surface of the light diffusion sheet to an observer's side. The light is thus diffused from the display device by use of the light diffusion sheet. This allows the display screen to be viewable from various directions. It is consequently possible to develop a display device capable of displaying a video having no difference between when being viewed at the front and when being viewed from an oblique direction, thereby being less dependent on viewing angle.

For example, Patent Literature 1 discloses a light diffusion sheet having a viewing surface (surface to be observed) having a plurality of grooves arranged in juxtaposition with each other. The plurality of grooves each have a substantially V-shaped cross section. The plurality of grooves have a light absorbing layer on their viewing surfaces. Patent Literature 2 discloses a light diffusion sheet having a viewing surface having a plurality of grooves arranged in juxtaposition with each other. The plurality of grooves have a substantially V-shaped cross section. The plurality of grooves each are partially filled with a light absorbent adhesive. According to the configurations disclosed in Patent Literatures 1 and 2, a part of stray light that passes through the light diffusion sheet is absorbed by the light absorbing layer or the light absorbent adhesive. This makes it possible to prevent a decrease in contrast, etc.

### CITATION LIST

### Patent Literature

Patent Literature 1
Japanese Patent Application Publication, Tokukai No. 2000-352608 A (Publication Date: Dec. 19, 2000)

Patent Literature 2
Japanese Patent Application Publication, Tokukai No. 2007-517929 A (Publication Date: Jul. 5, 2007)

### SUMMARY OF INVENTION

### Technical Problem

However, neither the light diffusion sheet disclosed in Patent Literature 1 nor the light diffusion sheet disclosed in Patent Literature 2 has sufficient light utilization efficiency and visual perceived display property. Specifically, Patent Literature 1 does not describe a concrete shape of the light absorbing layer. The drawing (FIG. 1), however, shows that the light absorbing layer is provided in the vicinity of an opening of each of the substantially V-shaped grooves, and is in contact with an oblique surface of the groove. Patent Literature 2 neither describes a concrete shape of the light absorbent adhesive. The drawing (FIG. 7B), however, shows that the light absorbent adhesive is applied to the vicinity of an opening of each of the substantially V-shaped grooves, and is in contact with an oblique surface of the groove. The light absorbent adhesive has a flat surface.

In the cases, video light that enters the vicinity of the opening of the groove, that is, video light that enters the light absorbing layer or the light absorbent adhesive that is in contact with the oblique surface of the groove is absorbed by the light absorbing layer or the light absorbent adhesive without being reflected. This causes a decrease in light utilization efficiency for utilizing the video light.

It is preferable to absorb light, such as stray light, which enters the light diffusion sheet at a wide incident angle to the light diffusion sheet, so as to improve a visual perceived display property. The light also enters the vicinity of a deepest part of the groove. The light, however, is not absorbed but transmitted and emitted as it is. This is because the light absorbing layer or the light absorbent adhesive is not provided in the vicinity of the deepest part of the groove. This causes a decrease in visual perceived display property of a display device.

The present invention was made in view of the problem, and an object of the present invention is to provide (i) a light diffusion sheet capable of (a) efficiently utilizing video light of a display device and (b) improving a visual perceived display property of the display device, (ii) a method for manufacturing the light diffusion sheet and (iii) a transmissive display device provided with the light diffusion sheet.

### Solution to Problem

In order to attain the object, a light diffusion sheet of the present invention is configured as a light diffusion sheet, including: a light diffusing section for diffusing light that has entered therein from a light entering surface so as to emit the diffused light from a light emitting surface, in which light diffusing section a plurality of concave parts each having a wall surface that transmits the light or totally reflects the light are formed; a support film provided on the light emitting surface of the light diffusing section; and a plurality of light absorbing sections supported by the support film, the plurality of light absorbing sections being provided independently in at least one of the plurality of respective concave parts, a gap being formed in the at least one of the plurality of respective concave parts such that the gap is formed between (i) a part of a wall surface of each concave part, which part is in a vicinity of an opening of the concave part and (ii) the light absorbing section provided in the concave part.

According to the configuration, the plurality of concave parts are formed in the light diffusing section, and the support film is provided on the light diffusing section. The plurality of light absorbing sections are formed in the plurality of respective concave parts such that respective gaps are formed between the plurality of concave parts and the plurality of light absorbing sections. Specifically, a gap having a width equivalent to or greater than a wavelength of the light to be subjected to total reflection is formed between the wall surface of the concave part and the light absorbing section at least in the vicinity of the opening of the concave part.

The gaps have a refractive index smaller than that of a general resin material. Therefore, the refractive index of the gaps becomes greatly different from that of the light diffusing section. This makes it possible to increase a critical angle of an incident angle of light that enters the light diffusion sheet, which critical angle allows the light to be subjected to total reflection. That is, according to the present embodiment, light that enters the light diffusion sheet at a wide incident angle to the light diffusion sheet can be subjected to total reflection, and then emitted as emission light. It is therefore possible to improve a utilization efficiency of light that has entered the light diffusion sheet. Further, light that has entered the vicinity of the opening of the concave part of the light diffusing section can be subjected to total reflection. It is therefore possible to further improve the utilization efficiency of light.

A display device employing the light diffusion sheet of the present invention can efficiently utilize light, and can prevent a visual perceived display property from changing depending on an angle at which the display device is viewed in a light emitting surface side. Though, light, such as stray light, enters the vicinity of a deepest part of the concave part, the light is absorbed by the light absorbing section. This is because the light absorbing section extends to the vicinity of the deepest part of the concave part. As such, it is possible to absorb the light, such as stray light, which causes a decrease in visual perceived display property of the display device. This allows an improvement in visual perceived display property of the display device.

In order to attain the object, a transmissive display device of the present invention includes the light diffusion sheet.

According to the configuration, it is possible to provide a display device which attains a wide viewing angle together with (i) a high light utilization efficiency, (ii) reduced stray light and (iii) a high visual perceived display property.

In order to attain the object, a method of the present invention for manufacturing a light diffusion sheet is arranged as a method for manufacturing a light diffusion sheet that includes a light diffusing section for diffusing light that has entered from a light entering surface so as to emit the diffused light from a light emitting surface, the method including the steps of: forming the light diffusing section on a lower base film; forming a plurality of concave parts in a surface of the light diffusing section, which surface is opposite to a surface that is in contact with the lower base film; forming a plurality of light absorbing sections on an upper base film; and adhering the light diffusing section and the upper base film to each other such that the plurality of light absorbing sections formed on the upper base film fit in the plurality of respective concave parts formed in the surface of the light diffusing section, the light diffusing section and the upper base film being adhered to each other such that a gap is formed between (i) a part of a wall surface of each of the plurality of concave parts, which part is in a vicinity of an opening of the concave part and (ii) the light absorbing section provided in the concave part.

According to the method, it is possible to provide a light diffusion sheet which has (i) a high light utilization efficiency, (ii) reduced stray light and (iii) a high visual perceived display property.

The method of the present invention for manufacturing a light diffusion sheet, further including the step of removing the lower base film from the light diffusing section adhered to the upper base film.

According to the method, a distance between a light source of a display device and the light diffusion sheet is reduced. This allows the display device provided with the light diffusion sheet to prevent an image blur caused by a multiple image.

For a fuller understanding of the nature and advantages of the invention, reference should be made to the ensuing detailed description taken in conjunction with the accompanying drawings.

### Advantageous Effects of Invention

In a light diffusion sheet of the present invention, a gap is formed between a concave part of a light diffusing section and a light absorbing section. Therefore, as much light as possible can be subjected to total reflection, and can be diffused. It is therefore possible to (i) improve a light utilization efficiency and (ii) efficiently absorb stray light by use of the light diffusing section. This allows provision of a light diffusion sheet having a high visual perceived display property.

### BRIEF DESCRIPTION OF DRAWINGS

FIG. 1

FIG. 1 is a view showing a cross section of a light diffusion sheet in accordance with an embodiment of the present invention.

FIG. 2

(a) of FIG. 2 is a view schematically showing a transmissive display device provided with a light diffusion sheet in accordance with an embodiment of the present invention. (b) of FIG. 2 is a view schematically showing a liquid crystal panel of a transmissive display device in accordance with an embodiment of the present invention.

FIG. 3

FIG. 3 is a view schematically showing a principle of a light diffusion sheet in accordance with an embodiment of the present invention.

FIG. 4

FIG. 4 is a view showing a process of adhering, to each other, (i) a lower base film on which a light diffusing section is provided and (ii) an upper base film on which light absorbing sections are formed.

FIG. 5

(a) of FIG. 5 is a view showing a process of adhering, to each other, (i) a lower base film on which a light diffusing section is provided and (ii) an upper base film on which light absorbing sections and an adhesive layer are formed. (b) of FIG. 5 is a view showing a cross section of a light diffusion sheet in which (i) a lower base film on which a light diffusing section is provided and (ii) an upper base film on which light absorbing sections and an adhesive layer are formed are adhered to each other.

FIG. 6

(a) of FIG. 6 is a view showing a process of adhering, to each other, (i) a lower base film on which a light diffusing section and an adhesive layer are provided and (ii) an upper base film on which light absorbing sections are formed. (b) of FIG. 6 is a view showing a cross section of a light diffusion sheet in which (i) a lower base film on which a light diffusing section and an adhesive layer are provided and (ii) an upper base film on which light absorbing sections are formed are adhered to each other.

FIG. 7

FIG. 7 is a view showing a cross section of a concave part of a light diffusing section, which concave part has a deepest part up to which a light absorbing section extends.

FIG. 8

(a) of FIG. 8 is a view showing a cross section of a concave part of a light diffusing section, in which concave part a light absorbing section has a triangular cross section having a base and a height whose aspect ratio is not less than 2 (two) but not more than 6 (six). (b) of FIG. 8 is a view showing a cross section of a concave part of a light diffusing section, in which concave part a light absorbing section has a triangular cross section having a base and a height whose aspect ratio is not less than 2 (two) but not more than 6 (six).

FIG. 9

(a) of FIG. 9 is a view showing a cross section of a concave part of a light diffusing section, which concave part has a wall surface with which a light absorbing section having a round edge is not in contact. (b) of FIG. 9 is a view showing a cross section of a concave part of a light diffusing section, which concave part has a wall surface with which a light absorbing section having a round edge is in contact.

FIG. 10

FIG. 10 is a view showing a process of forming a light absorbing section by accumulating convex parts each having a cross section whose aspect ratio is approximately 1 (one).

FIG. 11

(a) of FIG. 11 is a view showing a cross section of a concave part internally having a light absorbing section formed by accumulating a plurality of convex parts each having a round edge. (b) of FIG. 11 is a view showing a cross section of a concave part internally having a light absorbing section formed by accumulating a plurality of convex parts each having a quadragular cross section. (c) of FIG. 11 is a view showing a cross section of a concave part internally having a light absorbing section formed by accumulating a plurality of convex parts each having a quadragular cross section.

FIG. 12

(a) of FIG. 12 is a view showing a cross section of a concave part of a light diffusing section, which concave part has a convexoconcave wall surface. (b) of FIG. 12 is a view showing a cross section of a concave part internally having a light absorbing section having a convexoconcave oblique surface.

### DESCRIPTION OF EMBODIMENTS

### Schematic Description of Light Diffusion Sheet 1

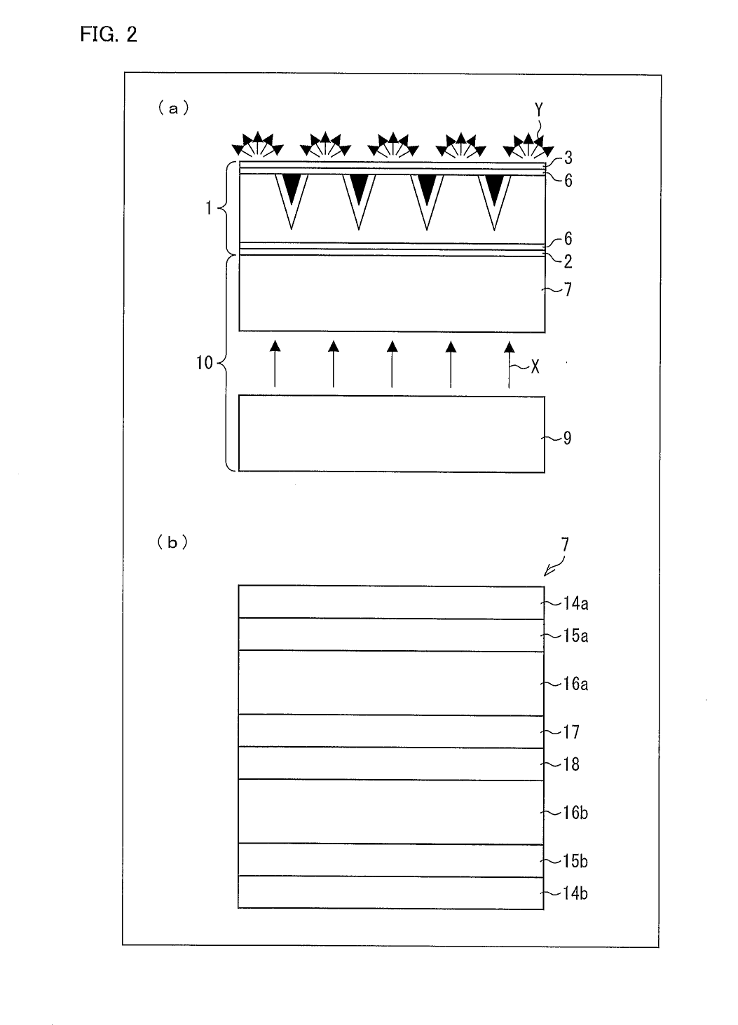

The following description will schematically discuss a light diffusion sheet of the present embodiment. A display device provided with the light diffusion sheet of the present embodiment is first described with reference to FIG. 2 before the configuration of the light diffusion sheet of the present embodiment is described. (a) of FIG. 2 is a view schematically showing a transmissive display device 10 provided with a light diffusion sheet 1 of the present embodiment. (b) of FIG. 2 is a view schematically showing a liquid crystal panel 7 of the transmissive display device 10 of the present embodiment.

As shown in (a) of FIG. 2, the light diffusion sheet 1 is adhered to a front surface of a display screen of the transmissive display device 10 such as a liquid crystal display device. The transmissive display device 10 includes a backlight section and a liquid crystal display device section. The transmissive display device 10 includes a backlight 9 serving as the backlight section, and a liquid crystal panel 7 serving as the liquid crystal display device section (see (a) of FIG. 2). As shown in (b) of FIG. 2, the liquid crystal panel 7 includes (i) a glass plate 16a on which, for example, a transparent electrode and a color filter 17 is provided, (ii) a glass plate 16b on which, for example, a thin film transistor (TFT) and wiring is provided, (iii) a liquid crystal layer 18 sealed between the glass plate 16a and the glass plate 16b, (iv) phase plates 15a and 15b, and (v) polarizing plates 14a and 14b. The phase plates 15a and 15b are provided on the glass plates 16a and 16b, respectively. The polarizing plates 14a and 14b are provided on the phase plates 15a and 15b, respectively.

The light diffusion sheet 1 diffuses incident light X emitted from the backlight 9 of the transmissive display device 10 to the display screen, so that emission light Y is emitted toward an observer. Thus, the light diffusion sheet 1 is used for spreading a viewing angle of the transmissive display device 10. A linear film, called a louver, can be provided in a blind manner between a light source and the light diffusion sheet 1, in providing the light diffusion sheet 1 on the transmissive display device 10. Further, in the case, the light source can be configured to emit light collimated or substantially collimated to parallel light.

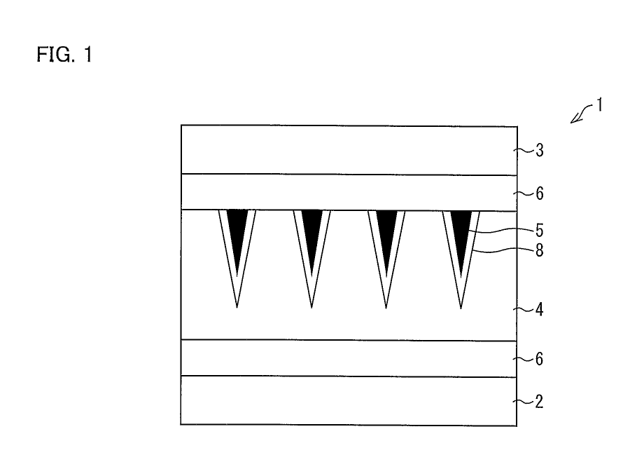

The following description will discuss a configuration of the light diffusion sheet 1 of the present embodiment with reference to FIG. 1. FIG. 1 is a view showing a cross section of the light diffusion sheet 1.

As shown in FIG. 1, the light diffusion sheet 1 includes a lower base film 2, an upper base film (support film) 3, a light diffusing section 4, a plurality of light absorbing sections 5, and adhesive layers 6. The light diffusing section 4, the plurality of light absorbing sections 5, and the adhesive layers 6 are provided between the lower base film 2 and the upper base film 3. Specifically, the light diffusing section 4 is provided on the lower base film 2 via one of the adhesive layers 6. The light diffusing section 4 has a side facing the upper base film 3, in which side a plurality of concave parts 8 are formed. Each of the plurality of concave parts 8 has a substantially V-shaped cross section taken along in a thickness direction of the light diffusing section 4. The substantially V-shaped cross section is tapered toward the lower base film 2. The plurality of concave parts 8 are arranged along one another at intervals. The plurality of light absorbing sections 5 are provided on the upper base film 3 via the other of the adhesive layers 6. Each of the plurality of light absorbing sections 5 has a triangular cross section, and the light absorbing section 5 having such a shape fits in a corresponding one of the plurality of concave parts 8 of the light diffusing section 4. The light absorbing section 5 is provided so as to face the concave part 8 of the light diffusing section 4.

The light diffusion sheet 1 is configured by adhering, to each other, (i) the lower base film 2 on which the light diffusing section 4 is provided and (ii) the upper base film 3 on which the plurality of light absorbing sections 5 are formed. Specifically, the lower base film 2 and the upper base film 3 are adhered to each other such that the plurality of light absorbing sections 5 fit in the plurality of respective concave parts 8. Note that the lower base film 2 and the upper base film 3 are adhered to each other such that there are respective gaps between the plurality of concave parts 8 and the plurality of light absorbing sections 5.

The light diffusion sheet 1 has, for example, the following concrete dimension. The lower base film 2 has a thickness of 100 μm, each of the adhesive layers 6 has a thickness of 10 μm, and the upper base film 3 has a thickness of 100 μm. The light diffusing section 4 has a thickness of 100 μm. Each of the plurality of concave parts 8 has a depth of 70 μm, and an opening whose width is 30 μm. Any adjacent ones of the plurality of concave parts 8 are provided at intervals of 30 μm. That is, the plurality of concave parts 8 of the light diffusing section 4 are provided at intervals of 30 μm. Note that these values are just one example among many, and therefore the technical scope of the present invention is not limited by the example at all.

According to the above configuration, light that has entered the concave part 8 from the lower base film 2 at a narrow incident angle to the light diffusion sheet 1, is subjected to total reflection on an interface between the light diffusing section 4 and the gap, and is then emitted. Meanwhile, light that has entered the concave part 8 from the lower base film 2 at a wide incident angle to the light diffusion sheet 1 is not transmitted through the light diffusion sheet 1 but absorbed by the light absorbing section 5. This allows not only an increase in utilization efficiency of light that has entered the light diffusion sheet 1 but also an improvement in visual perceived display property. This will be later described in detail.

(Light Diffusivity of the Light Diffusion Sheet 1)

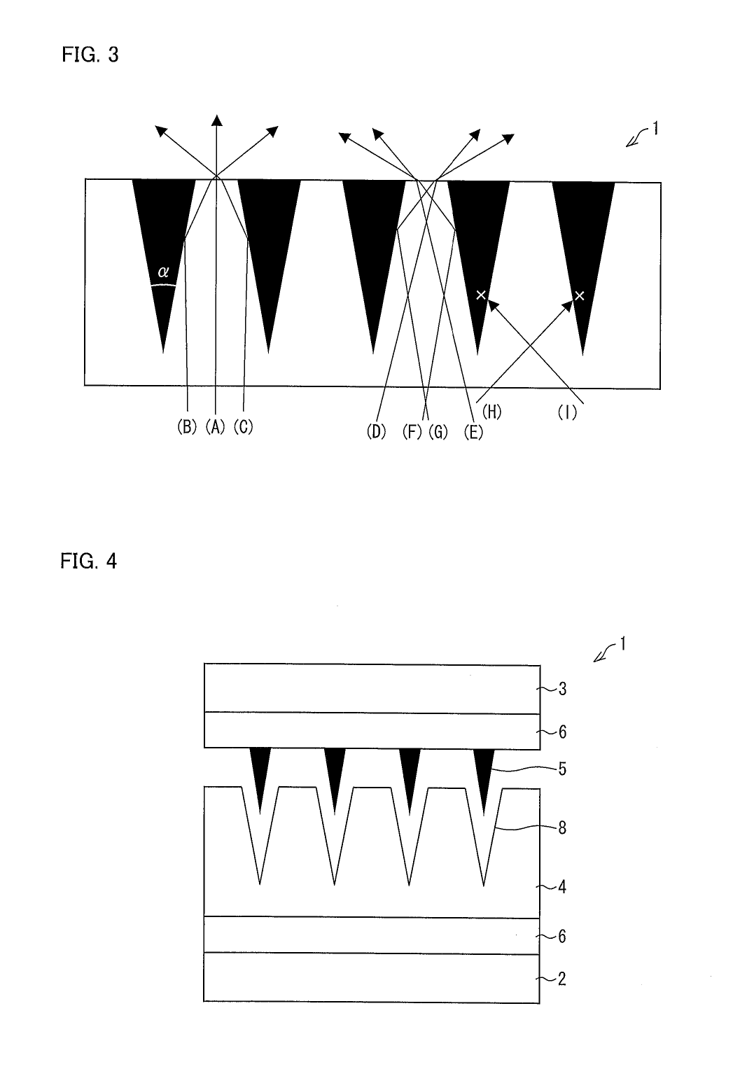

The following description will discuss a principle of the light diffusion sheet 1 with reference to FIG. 3. FIG. 3 is a view schematically showing the principle of the light diffusion sheet 1. FIG. 3 schematically shows the light diffusion sheet 1, so that reflection of light is clarified.

Light enters the light diffusion sheet 1 from a lower base film 2 side that is a light entering surface side, and the light is emitted from an upper base film 3 side that is a light emitting surface side. Light that has entered the light diffusion sheet 1 perpendicularly to the light diffusion sheet 1 is emitted as it is via the light diffusing section 4, as indicated by an arrow (A) of FIG. 3. Light, indicated by arrows (B) and (C) of FIG. 3, which has reaches the concave part 8 of the light diffusing section 4, is subjected to total reflection on the interface between the gap and the light diffusing section 4, and is then diffused and emitted.

Light, indicated by arrows (D) and (E) of FIG. 3, which has entered the light diffusion sheet 1 at a narrow incident angle to the light diffusion sheet 1 is diffused and emitted as it is via the light diffusing section 4. Light, indicated by arrows (F) and (G) of FIG. 3, which has reached the concave part 8 of the light diffusing section 4, is subjected to total reflection on the interface between the gap and the light diffusing section 4, and is then diffused and emitted.

Light, indicated by arrows (H) and (I) of FIG. 3, which has entered the light diffusion sheet 1 at a wide incident angle to the light diffusion sheet 1 and has reached the concave part 8, is absorbed by the light absorbing section 5 without being subjected to total reflection.

It is therefore possible to widely spread, from the light emitting surface side (the upper base film 3 side), (i) the light that has entered the light diffusion sheet 1 perpendicularly to the light diffusion sheet 1 and (ii) the light that has entered the light diffusion sheet 1 at a narrow incident angle to the light diffusion sheet 1. This makes it possible to prevent a visual perceived display property from being changed due to an angle at which the light emitting surface side is viewed. Light, such as stray light, which enters the light diffusion sheet 1 at a wide incident angle to the light diffusion sheet 1 enters the vicinity of a deepest part of the concave part 8. However, the light is absorbed by the light absorbing section 5 because the light absorbing section 5 extends to the vicinity of the deepest part of the concave part 8. In this way, it is possible to absorb the light, such as stray light, which decreases a visual perceived display property of a display device. This can improve the visual perceived display property of the display device. Further, with this configuration, light that has entered the vicinity of an opening of the concave part 8 of the light diffusing section 4 can be subjected to total reflection, whereby a light utilization efficiency can be increased.

Note that the light diffusion sheet 1 has a critical angle of an incident angle of light that enters the light diffusion sheet 1, which critical angle allows the light to be subjected to total reflection. Increase in the critical angle increases light to be subjected to total reflection, so that the light utilization efficiency can be improved. The critical angle changes depending on (i) a refractive index of the light diffusing section 4, (ii) a refractive index of a material which is provided inside the concave part 8 of the light diffusing section 4 and (iii) an angle made by the concave part 8 of the light diffusing section 4. Specifically, critical angle θ_{MAX} is represented by the following expression (1):

$$[ Math 1 ]$$

$${θ}_{MAX} = {sin}^{- 1} [ N 1 \times sin \{ {cos}^{- 1} ( \frac{N 2}{N 1} ) + \frac{α}{2} \} ] \qquad ( 1 )$$

where the refractive index of the light diffusing section 4 is N1, the refractive index of the material which is provided inside the concave part 8 is N2, and the angle made by the concave part 8 is α.

According to the expression (1), the critical angle θ_{MAX} can be increased by increase in N1 and α, and decrease in N2. That is, the critical angle θ_{MAX} is increased as (i) a difference between N1 and N2 (N1>N2) and (ii) α are increased.

It is therefore preferable in the present embodiment to increase (i) a difference between the refractive index of the light diffusing section 4 and a refractive index of the gap and (ii) the angle made by the concave part 8 of the light diffusing section 4. It is, specifically, preferable that the light diffusing section 4 have a refractive index of more than 1.0 because the gap has a refractive index of 1.0. This makes it possible to improve a light utilization efficiency of the light diffusion sheet 1.

As described above, according to the present embodiment, there is the gap between the concave part 8 of the light diffusing section 4 and the light absorbing section 5. Note that the gap has a refractive index smaller than that of a general resin. Therefore, the difference between the refractive index of the light diffusing section 4 and the refractive index of the gap becomes greater than that between the refractive index of the light diffusing section 4 and a refractive index of a resin having a lower refractive index, which resin is provided inside a concave part 8 of a conventional light diffusion sheet. It is therefore possible to increase the critical angle of the incident angle of the light that enters the light diffusion sheet 1, which critical angle allows the light to be subjected to total reflection. That is, according to the present embodiment, the light that has entered the light diffusion sheet 1 at the wide incident angle to the light diffusion sheet 1 can be subjected to total reflection, and can be emitted as emission light.

The conventional light diffusion sheet can efficiently subject, to total reflection, light that has entered the conventional light diffusion sheet substantially perpendicularly to the conventional light diffusion sheet (i.e., light that has entered the conventional light diffusion sheet at angles ranging from 10° to −10° to a direction perpendicular to the conventional light diffusion sheet). However, a utilization efficiency of light that has entered the conventional light diffusion sheet at an angle other than the angles is low. In contrast, the light diffusion sheet 1 of the present embodiment can improve, by approximately 80%, a utilization efficiency of light that enters the light diffusion sheet 1 at angles of not less than 10° or not more than −10° to the direction perpendicular to the light diffusion sheet 1. This is because the light diffusion sheet 1 of the present embodiment has an increased difference between the refractive index of the concave part 8 of the light diffusing section 4 and the refractive index of the gap. Consequently, it is possible to improve a whole light utilization efficiency by approximately 30%.

According to the present embodiment, there is the gap between the concave part 8 of the light diffusing section 4 and the light absorbing section 5. Note, however, that the gap can be a gap that is at least partially formed between the concave part 8 and the light absorbing section 5. Specifically, a gap having a width equivalent to or greater than a wavelength of the light to be subjected to total reflection is formed between a wall surface of the concave part 8 and the light absorbing section 5 in the vicinity of the opening of the concave part 8.

(Members of the Light Diffusion Sheet 1)

The following description will discuss members of the light diffusion sheet 1.

Each of the lower base film 2 and the upper base film 3 can be made from, for example, a transparent base film material disclosed in Japanese Patent Application Publication, Tokukai No. 2007-517929. One Example of the transparent base film material is a film of polyethylene terephthalate, polycarbonate, polyester, acryl, polyolefine, polypropylene or vinyl. The lower base film 2 and the upper base film 3 should be made from a transparent material, so that light (video light) of a display device can enter the lower base film 2, and be then emitted from the upper base film 3.

The light diffusing section 4 can be made from, for example, a resin material having a high refractive index, which resin material is disclosed in Japanese Patent Application Publication, Tokukai No. 2007-517292. Examples of the resin material encompass (i) polymethyl methacrylate resin (PMMA), (ii) modified acrylic resin and (iii) a transparent polymer resin of, for example, polycarbonate, polystylene, polyester, polyolefine, polypropylene or other optical polymers.

The light absorbing section 5 can be made from, for example, (i) a pigment-containing resin, such as carbon black, which is generally used for black matrix, (ii) metals such as low reflecting chromium, low reflecting duplex nickel alloy, or a laminated film of molybdenum (Mo)/molybdenum oxide (MoOx) or (iii) a combination of a resin with at least one of the materials. The light absorbing section 5 can also be made from a black resin having a high refractive index.

The concave part 8, which has the substantially V-shaped cross section, preferably has a conical shape or a substantially pyramid shape such as a quadrangular pyramid. However, the shape of the concave part 8 is not necessarily limited to the above shape provided that the concave part 8 has a shape which enables light to be at least radially diffused. For example, the cross section of the concave part 8 can have two oblique sides that are asymmetric. Alternatively, the concave part 8 can have a polygonal cross section or a curved wall surface. This allows a single above-configured light diffusion sheet 1 to efficiently diffuse light. It is therefore possible to obtain a wide viewing angle. The light absorbing section 5 can have a shape determined in accordance with the shape of the concave part 8 of the light diffusing section 4.

According to the present embodiment, the plurality of concave parts 8 are arranged along one another. However, the arrangement of the plurality of concave parts 8 is not limited to a specific one. For example, the plurality of concave parts 8 can be arranged at random. Alternatively, a plurality of concave parts 8, each of which is configured to be a groove whose cross section is substantially V-shaped, are arranged along one another in a light emitting surface side of the light diffusing section 4. In this case, the plurality of light absorbing sections 5 are tapered in accordance with the respective grooves.

The adhesive layers 6 are not particularly limited to a specific one. The adhesive layers 6 can be made from, for example, a conventional adhesive material. The adhesive layers 6 can also serve as a scattering layer. In this case, the adhesive layers 6 can include a diffusing agent such as light diffusing fine particles. In a case where the adhesive layers 6 serve as a scattering layer, the scattering layer is provided in a side where light (video light) of a display device, which light has entered the light diffusion sheet 1, is scattered. That is, the scattering layer is provided in the upper base film 3 side.

Note that the adhesive layers 6 need not to be provided in a case where each of the material of the light diffusing section 4 and the material of the light absorbing section 5 has an adhesiveness enough to directly adhere to the respective base films.

(Method for Manufacturing the Light Diffusion Sheet 1)

The following description will discuss a method for manufacturing the light diffusion sheet 1, with reference to FIG. 4. FIG. 4 is a view showing a process of adhering, to each other, (i) the lower base film 2 on which the light diffusing section 4 is provided and (ii) the upper base film 3 on which the plurality of light absorbing sections 5 are formed. The method for manufacturing the light diffusion sheet 1 is explained by description of a concrete example. However, the method for manufacturing the light diffusion sheet 1 of the present embodiment is not limited to the concrete example.

The lower base film 2 on which the light diffusing section 4 is provided is first formed (a process of forming a lower base film). A light diffusing section having concave shapes (the plurality of concave parts 8) formed by, for example, a cutting method, is formed on the lower base film 2 via the adhesive layer 6 (a process of forming a light diffusing section, and a process of forming concave parts). Instead of the cutting method, it is possible to form the concave shapes by a method disclosed in, for example, Japanese Patent Application Publication Tokukai No. 2000-352608 A, Japanese Patent Application Publication Tokukai No. 2004-4148 A, Japanese Translation of PCT International Application Tokuhyo No. 2007-517929 A, Japanese Patent Application Publication Tokukai No. 2008-90324 A, or Japanese Patent Application Publication Tokukai No. 2008-102547 A. Specifically, it is possible to employ a production device including (i) a forming roll on which surface a plurality of convex parts whose shapes are inversion of those of the plurality of respective concave parts 8 of the light disusing section 4 are formed, and (ii) a pressing roll that is in contact with the forming roll and is capable of pressing, for example, a thin film to the forming roll. A material of the light diffusing section 4 is applied to the surface of the forming roll while the forming roll is being rotated. Rotation of the pressing roll causes the lower base film 2 on which an adhesive layer 6 is provided to be supplied onto the material of the light diffusing section 4 applied to the forming roll. The material of the light diffusing section 4, and the lower base film 2 on which the adhesive layer 6 is provided are pressurized at a nip section between the forming roll and the pressing roll. Thereafter, the material of the light diffusing section 4, and the lower base film 2 on which the adhesive layer 6 is provided are cured. This makes it possible to obtain an integrated lamination of (a) the light diffusing section 4 having the plurality of concave parts 8 and (b) the lower base film 2, with the adhesive layer 6 provided between the light diffusing section 4 and the lower base film 2.

The upper base film 3 on which the plurality of light absorbing sections 5 are formed is secondly formed (a process of forming an upper base film). The plurality of light absorbing sections 5 each having a convex shape are formed on the upper base film 3 via an adhesive layer 6 by means of, for example, printing or transferring (a process of forming light absorbing sections). The plurality of light absorbing sections 5 can be formed by a method disclosed in, for example, Japanese Patent Application Publication Tokukai No. 2004-4148 A (see FIG. 20). Specifically, the plurality of light absorbing sections 5 are formed by use of a production device including (i) a mold roll on which surface molds (in which the plurality of light absorbing sections 5 fit) each having a triangular cross section are curved, (ii) a feeder that is in contact with the mold roll and (iii) a supply roll. The triangular molds curved on the mold roll are filled with a material of the plurality of light absorbing sections 5 while the mold roll is being rotated. The material is then cured. Thereafter, the adhesive layer 6 is supplied onto the mold roll while the feeder is being rotated. The upper base film 3 is supplied onto the mold roll while the supply roll is being rotated. The adhesive layer 6 and the upper base film 3 are cured. This makes it possible to unite, via the adhesive layer 6, (a) the plurality of light absorbing sections 5 each having a triangular cross section and (b) the upper base film 3.

The lower base film 2 on which the light diffusing section 4 is provided, and the upper base film 3 on which the plurality of light absorbing sections 5 are formed are adhered to each other (an adhering process). Specifically, the lower base film 2 and the upper base film 3 are adhered to each other via the adhesive layer 6 formed on the upper base film 3, such that the plurality of light absorbing sections 5 fit in the plurality of respective concave parts 8 of the light diffusing section 4 (see FIG. 4). More specifically, the lower base film 2 and the upper base film 3 are adhered to each other such that there are respective gaps between the plurality of light absorbing sections 5 and the plurality of concave parts 8 of the light diffusing section 4. Thus, the light diffusion sheet 1 can be manufactured.

The lower base film 2 can be removed from the light diffusion sheet 1 in which the lower base film 2 and the upper base film 3 are adhered to each other (a process of removing a lower base film). The removing of the lower base film 2 does not cause any problems because the upper base film 3 serves as a support substrate of the light diffusion sheet 1. The removing of the lower base film 2, on the contrary, allows reduction in distance between a light source of a display device and the light diffusion sheet 1. It is therefore possible to suppress an image blur caused by a multiple image.

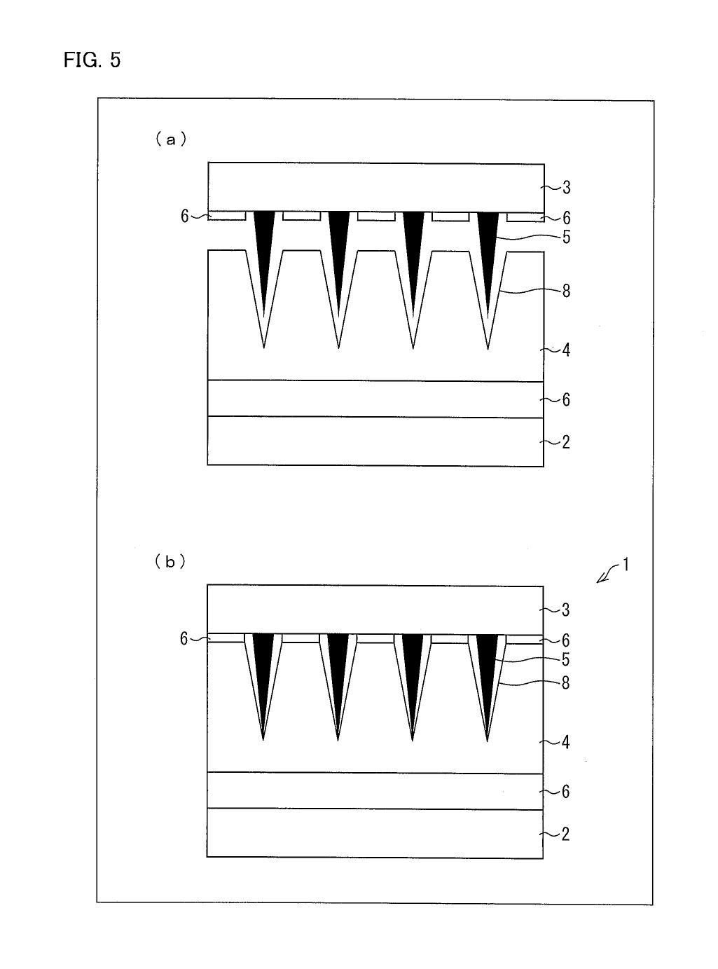

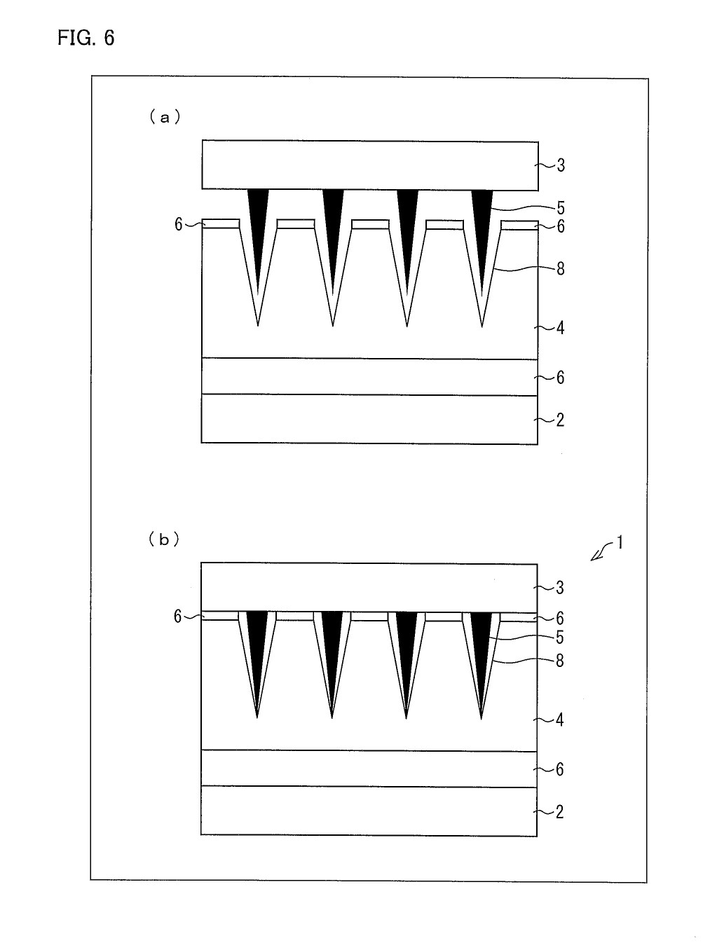

The above description discussed a method for providing the adhesive layer 6 on the upper base film 3 and forming the plurality of light absorbing sections 5 on the upper base film 3 via the adhesive layer 6. However, how to form the plurality of light absorbing sections 5 is not necessarily limited to the method. The plurality of light absorbing sections 5 can be directly formed on the upper base film 3 provided that the plurality of light absorbing sections 5 have a sufficient adhesiveness. In this case, it is necessary to provide an adhesive layer 6 via which (i) the lower base film 2 on which the light diffusing section 4 is provided and (ii) the upper base film 3 on which the plurality of light absorbing sections 5 are formed are adhered to each other. This is explained with reference to FIGS. 5 and 6. (a) of FIG. 5 is a view showing a process of adhering, to each other, (i) the lower base film 2 on which the light diffusing section 4 is provided and (ii) the upper base film 3 on which the plurality of light absorbing sections 5 and the adhesive layer 6 are formed. (b) of FIG. 5 is a view showing a cross section of the light diffusion sheet 1 in which (i) the lower base film 2 on which the light diffusing section 4 is provided and (ii) the upper base film 3 on which the plurality of light absorbing sections 5 and the adhesive layer 6 are formed are adhered to each other. (a) of FIG. 6 is a view showing a process of adhering, to each other, (i) the lower base film 2 on which the light diffusing section 4 and the adhesive layer 6 are provided and (ii) the upper base film 3 on which the plurality of light absorbing sections 5 are formed. (b) of FIG. 6 is a view showing a cross section of the light diffusion sheet 1 in which (i) the lower base film 2 on which the light diffusing section 4 and the adhesive layer 6 are provided and (ii) the upper base film 3 on which the plurality of light absorbing sections 5 are formed are adhered to each other.

For example, on the upper base film 3, the adhesive layer 6 for adhering (i) the lower base film 2 on which the light diffusing section 4 is provided and (ii) the upper base film 3 on which the plurality of light absorbing sections 5 are formed can be provided. Specifically, as shown in (a) of FIG. 5, the adhesive layer 6 is formed on the upper base film 3 between any adjacent ones of the plurality of light absorbing sections 5, that is, on a part of the upper base film 3, on which part no light absorbing section 5 is formed. The adhesive layer 6 is formed on the upper base film 3 by means of, for example, application, transfer or adhesion. Note that the adhesive layer 6 is formed so as not to come into contact with any one of the plurality of light absorbing sections 5. As shown in (b) of FIG. 5, (i) the lower base film 2 on which the light diffusing section 4 is provided and (ii) the upper base film 3 on which the plurality of light absorbing sections 5 are formed are then adhered to each other via the adhesive layer 6 formed on the upper base film 3. Note that the adhering is carried out lest the adhesive layer 6 extended by pressure comes into contact with any one of the plurality of light absorbing sections 5 and fills the respective gaps between the plurality of concave parts 8 and the plurality of light absorbing sections 5.

The adhesive layer 6 can also be provided on the lower base film 2, via which adhesive layer 6 (i) the lower base film 2 on which the light diffusing section 4 is provided and (ii) the upper base film 3 on which the plurality of light absorbing sections 5 are formed are adhered to each other. Specifically, as shown in (a) of FIG. 6, the adhesive layer 6 is formed on the lower base film 2 between any adjacent ones of the plurality of concave parts 8 of the light diffusing section 4, that is, on a part of the lower base film 2, on which part no concave part 8 is formed. The adhesive layer 6 is formed on the upper base film 3 by means of, for example, application, transfer or adhesion. Note that the adhesive layer 6 is formed so as not to protrude into any one of the plurality of concave parts 8. As shown in (b) of FIG. 6, (i) the lower base film 2 on which the light diffusing section 4 is provided and (ii) the upper base film 3 on which the plurality of light absorbing sections 5 are formed are then adhered to each other via the adhesive layer 6 formed on the lower base film 2. Note that the adhering is carried out lest the adhesive layer 6 extended by pressure comes into contact with any one of the plurality of light absorbing sections 5 and fills the respective gaps between the plurality of concave parts 8 and the plurality of light absorbing sections 5.

(Example 1 of a Shape of the Light Absorbing Section 5)

As early described, according to the present embodiment, the shape of the light absorbing section 5 is not limited to a specific one provided that the gap between the concave part 8 of the light diffusing section 4 and the light absorbing section 5 is formed at least in the vicinity of the opening of the concave part 8, in which gap light is subjected to total reflection. For example, the light absorbing section 5 can extend to a deepest part of the concave part 8. The following description will discuss an example 1 of the shape of the light absorbing section 5 with reference to FIG. 7. FIG. 7 is a view showing a cross section of the concave part 8 of the light diffusing section 4, which concave part 8 has a deepest part to which the light absorbing section 5 extends.

It is possible to absorb light that has entered the vicinity of the deepest part of the concave part 8 in a case where the light absorbing section 5 extends to the deepest part of the concave part 8 of the light diffusing section 4 (see FIG. 7). That is, it is possible to absorb light, such as stray light, which enters the vicinity of the deepest part of the concave part 8 of the light diffusing section 4. This allows an improvement in visual perceived display property of a display device. Though the light absorbing section 5 extends to the deepest part of the concave part 8 of the light diffusing section 4, there is still a gap between the light absorbing section 5 and the concave part 8. The gap has a refractive index greatly different from that of the light diffusing section 4. It is therefore possible to increase, by approximately 78%, a utilization efficiency of light that enters at angles of not less than 10° or not more than −10° to the direction perpendicular to the light diffusion sheet 1. This consequently allows a whole light utilization efficiency to be increased by approximately 29%. It is thus possible to attain a sufficient light diffusivity even in a case where the light absorbing section 5 extends to the deepest part of the concave part 8 of the light diffusing section 4.

(Example 2 of the Shape of the Light Absorbing Section 5)

The light absorbing section 5 can have a triangular cross section having a base and a height whose aspect ratio is high, instead of the example 1 of the shape of the light absorbing section 5. Such a high aspect ratio is obtained by, for example, shortening the base. The following description will discuss an example 2 of the shape of the light absorbing section 5 with reference to FIG. 8. (a) of FIG. 8 is a view showing a cross section of a concave part 8 of a light diffusing section 4, which concave part 8 internally has a light absorbing section 5 whose triangular cross section has a base and a height whose aspect ratio is not less than 2 (two) but not more than 6 (six). (b) of FIG. 8 is a view showing a cross section of the concave part 8 of the light diffusing section 4, which concave part 8 internally has a light absorbing section 5 whose triangular cross section has a base and a height whose aspect ratio is not less than 2 (two) but not more than 6 (six).

A light absorbing section 5 having a triangular cross section whose aspect ratio is high can contribute to reduction in its volume. It is therefore possible to reduce a manufacturing cost of the light absorbing section 5. Decrease in accuracy at which (i) the lower base film 2 on which the light diffusing section 4 is provided and (ii) the upper base film 3 on which the light absorbing section 5 is formed are located possibly causes the lower base film 2 and the upper base film 3 to be misalignedly adhered to each other. In this case, the light absorbing section 5 possibly comes into contact with a wall surface of the concave part 8 of the light diffusing section 4, depending on how much the lower base film 2 and the upper base film 3 are misaligned. In a case where the light absorbing section 5 comes into contact with the wall surface of the concave part 8 of the light diffusing section 4, the light absorbing section 5 absorbs light that has entered a part of the light absorbing section 5, which part comes into contact with the wall surface of the concave part 8. This causes a decrease in light utilization efficiency, and therefore a visual perceived display property is decreased.

However, the light absorbing section 5 having the triangular cross section whose aspect ratio is high (see (a) and (b) of FIG. 8) is unlikely to come into contact with the wall surface of the concave part 8 of the light diffusing section 4 even in a case where the lower base film 2 and the upper base film 3 are misalignedly adhered to each other. It is therefore possible to prevent a decrease in light utilization efficiency caused by contact of the light absorbing section 5 with the wall surface of the concave part 8 of the light diffusing section 4.

As early described, it is preferable to employ the light absorbing section 5 having the triangular cross section whose aspect ratio is high. It is, however, more preferable to employ a light absorbing section 5 having a triangular cross section whose aspect ratio is not less than 2 (two) but not more than 6 (six). This is because a critical angle of an incident angle of light that enters the light diffusion sheet 1, which critical angle allows the light to be subjected to total reflection, is reduced in a case where the aspect ratio is not more than 2 (two). This is also because a light absorbing section 5 having an aspect ratio of not less than 6 (six) has a small size, and it is therefore difficult to form such a small light absorbing section 5. Meanwhile, in a case where the aspect ratio is not more than 2 (two) but not less than 6 (six), the critical angle of the incident angle of the light that enters the light diffusion sheet 1, which critical angle allows the light to be subjected to total reflection, is sufficiently great. Further, in this case, the size of the light absorbing section 5 is not too small. It is therefore not difficult to form the light absorbing section 5.

(Example 3 of the Shape of the Light Absorbing Section 5)

According to the present embodiment, the light, such as stray light, which has entered the vicinity of the deepest part of the concave part 8 of the light diffusing section 4 is absorbed by the light absorbing section 5. It is therefore preferable that the light absorbing section 5 be tapered. Such a tapered light absorbing section 5 can absorb the light, such as stray light, which has entered the vicinity of the deepest part of the concave part 8 of the light diffusing section 4. A light absorbing section 5 formed by means of, for example, printing is possibly separated from a production device. Alternatively, an inclined surface of the light absorbing section 5 is possibly melted and sagged by heat. This consequently causes the light absorbing section 5 to have a round edge.

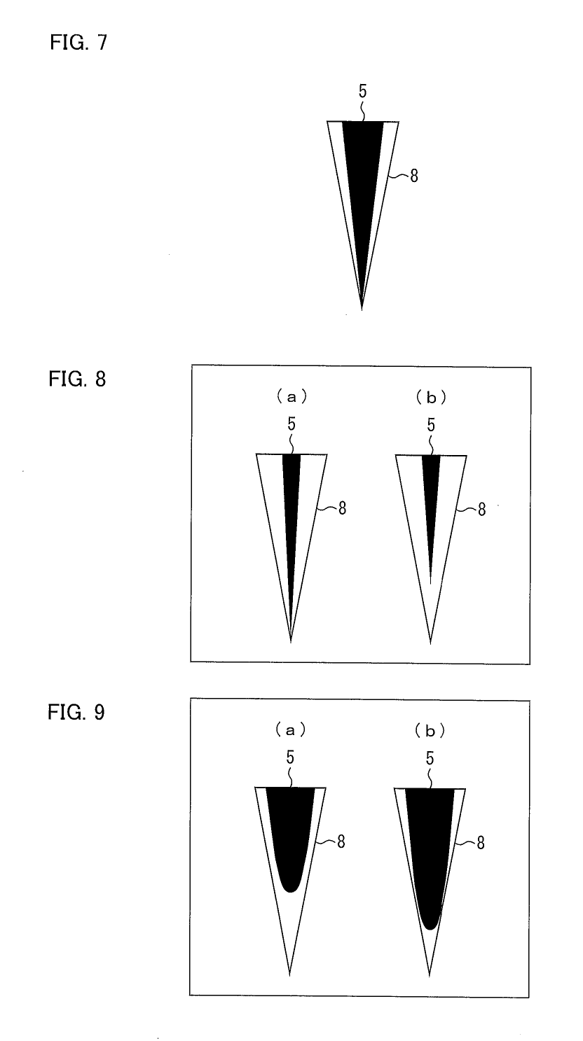

It is possible to prevent the light absorbing section from having the round edge by forming the light absorbing section 5 by use of a material which is not melted and sagged by heat. In this case, however, materials applicable for the light absorbing section 5 are limited. In other words, the forming of the light absorbing section 5 having the round edge allows the light absorbing section 5 to be made from a material selected from a wide range of materials for the light absorbing section 5. Therefore, the light absorbing section 5 of the present embodiment can have a round edge. The following description will discuss an example 3 of the shape of the light absorbing section 5 with reference to FIG. 9. (a) of FIG. 9 is a view showing a cross section of a concave part 8 of a light diffusing section 4, which concave part 8 internally has a light absorbing section 5 which (i) has a round edge and (ii) does not come into contact with a wall surface of the concave part 8. (b) of FIG. 9 is a view showing a cross section of a concave part 8 of a light diffusing section 4, which concave part 8 internally has a light absorbing section 5 which (i) has a round edge and (ii) is in contact with a wall surface of the concave part 8.

(a) of FIG. 9 shows the light absorbing section 5 whose edge is round. The light absorbing section 5 does not have a tapered edge. Therefore, the light absorbing section 5 cannot absorb light that has entered the vicinity of a deepest part of the concave part 8 of the light diffusing section 4. In order that the light absorbing section 5 can absorb the light, the light absorbing section 5 can be formed (i) so as to come into contact with the wall surface of the concave part 8 of the light diffusing section 4 and (ii) such that the edge of the light absorbing section 5 extends to the deepest part of the concave part 8 (see (b) of FIG. 9). Such a formed light absorbing section 5 can absorb the light that has entered the vicinity of the deepest part of the concave part 8 of the light diffusing section 4. The light absorbing section 5, however, absorbs light that has entered a part of the light absorbing section 5, which part is in contact with the wall surface of the concave part 8 of the light diffusing section 4. Meanwhile, the part has a small surface area since the edge of the light absorbing section 5 is round. Therefore, the light absorbing section 5 absorbs less light in the part, and a visual perceived display property of a display device is hardly decreased by absorption of the light that has entered the part.

Even in a case where the light absorbing section 5 is in contact with the wall surface of the concave part 8, there is still a gap between the light absorbing section 5 and the concave part 8. The gap has a refractive index greatly different from that of the light diffusing section 4. It is therefore possible to increase, by approximately 75%, a utilization efficiency of light that enters at angles of not less than 10° or not more than −10° to the direction perpendicular to the light diffusion sheet 1. This consequently allows a whole light utilization efficiency to be increased by approximately 27%. It is thus possible to attain a sufficient light diffusivity even in a case where the light absorbing section 5 having the round edge is in contact with the wall surface of the concave part 8 of the light diffusing section 4. Further, the light absorbing section 5 can be made from a material selected from a wide range of materials for the light absorbing section 5 because the light absorbing section 5 needs not have a tapered edge.

(Example 4 of the Shape of the Light Absorbing Section 5)

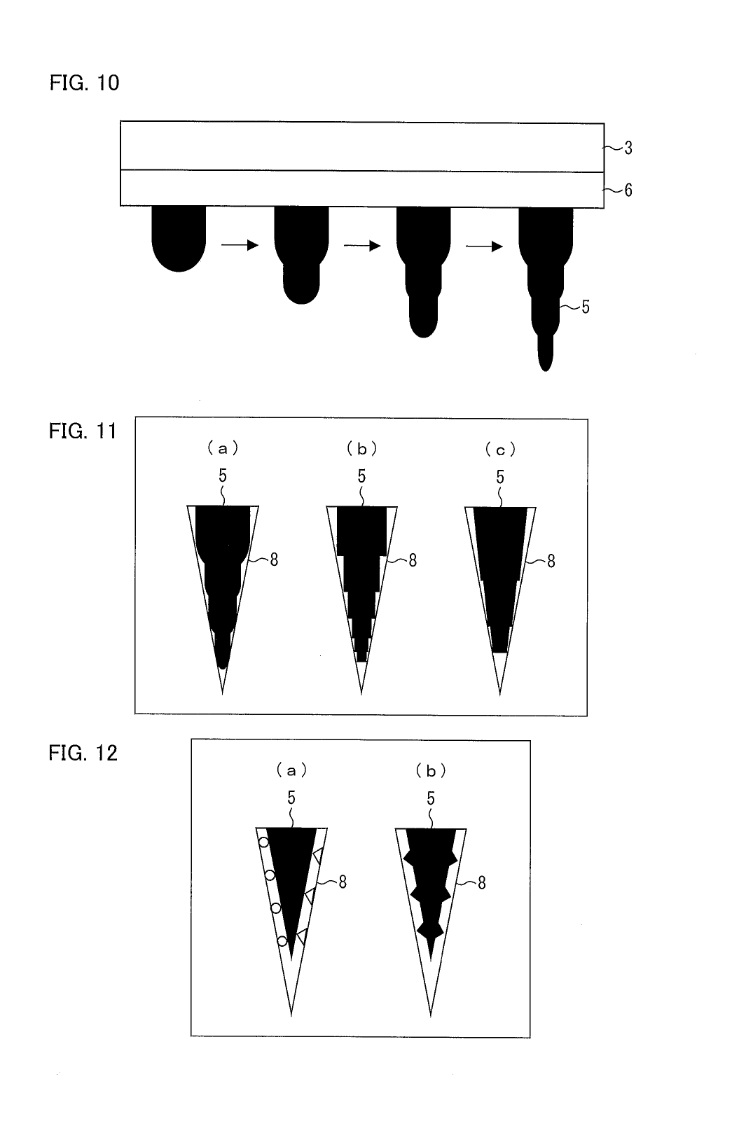

As early described, it is preferable to employ the light absorbing section 5 having the triangular cross section whose aspect ratio is high. It is, however, difficult to form the light absorbing section 5 at a one-time printing in a case where the light absorbing section 5 is formed by means of, for example, a printing method. In order to easily form the light absorbing section 5, convex parts each having a cross section whose aspect ratio is approximately 1 (one) is accumulated, so that a light absorbing section 5 having a cross section whose aspect ratio is high can be formed. The following description will discuss an example 4 of the shape of the light absorbing section 5 with reference to FIGS. 10 and 11. FIG. 10 is a view showing a process of forming a light absorbing section 5 by accumulating convex parts each having a cross section whose aspect ratio is approximately 1 (one). (a) of FIG. 11 is a view showing a cross section of a concave part 8 internally having a light absorbing section 5 formed by accumulating a plurality of convex parts each having a round edge. (b) of FIG. 11 is a view showing a cross section of a concave part 8 internally having a light absorbing section 5 formed by accumulating a plurality of convex parts each having a quadrangular cross section. (c) of FIG. 11 is a view showing a cross section of a concave part 8 internally having a light absorbing section 5 formed by accumulating a plurality of convex parts each having a quadrangular cross section.

As shown in FIG. 10, a convex part having a cross section whose aspect ratio is approximately 1 (one) is printed on an adhesive layer 6, and another convex part having a cross section whose aspect ratio is approximately 1 (one) is printed on the convex part. This process is carried out several times so as to accumulate convex parts, so that a light absorbing section 5 having a cross section whose aspect ratio is high can be finally formed. Note that the convex parts to be sequentially accumulated are gradually reduced in size such that the light absorbing section 5 fits in the concave part 8 of the light diffusing section 4.

As shown in FIG. (a) of FIG. 11, the light absorbing section 5 thus formed comes into contact with several parts of a wall surface of the concave part 8 of the light diffusing section 4 when the light absorbing section 5 fits in the concave part 8 of the light diffusing section 4. Though the light absorbing section 5 is in contact with the several parts of the wall surface of the concave part 8, the several parts have a small surface area. This is because the light absorbing section 5 is formed by accumulating the convex parts each having a round edge. Therefore, the light absorbing section 5 absorbs less light in the several parts, and a visual perceived display property of a display device is hardly decreased by absorption of the light that has entered the several parts.

Even in a case where the light absorbing section 5 is in contact with the several parts of the wall surface of the concave part 8, there is still a gap between the light absorbing section 5 and the concave part 8. The gap has a refractive index greatly different from that of the light diffusing section 4. It is therefore possible to increase, by approximately 75%, a utilization efficiency of light that enters at angles of not less than 10° or not more than −10° to the direction perpendicular to the light diffusion sheet 1. This consequently allows a whole light utilization efficiency to be increased by approximately 27%. It is thus possible to attain a sufficient light diffusivity even in a case where the light absorbing section 5 having the round edge is in contact with the wall surface of the concave part 8 of the light diffusing section 4. Further, the light absorbing section 5 can be made from a material selected from a wide range of materials for the light absorbing section 5 because the light absorbing section 5 needs not have a tapered edge.

The several parts thus have the small surface area. It is therefore possible to reduce as much as possible a surface area of an inclined surface of the light absorbing section 5, which inclined surface comes into contact with the wall surface of the concave part 8, even in a case where upper and lower base films are misalignedly adhered to each other.

As shown in FIG. 10, the light absorbing section 5 is formed by accumulating the convex parts each having the round edge. However, the shape of the light absorbing section 5 is not necessarily limited to this. Alternatively, for example, the light absorbing section 5 can be formed by accumulating convex parts each having a quadrangular cross section.

(b) of FIG. 11 shows the cross section of the concave part 8 internally having the light absorbing section 5 formed by accumulating the plurality of convex parts each having the quadrangular cross section. As shown in (b) of FIG. 11, the light absorbing section 5 is in contact with several parts of a wall surface of the concave part 8 of a light diffusing section 4. Though the light absorbing section 5 is in contact with the several parts of the wall surface of the concave part 8, the several parts have a small surface area. This is because the light absorbing section 5 has sharp corners via which the light absorbing section 5 is in contact with the wall surface of the concave part 8. It is therefore possible to bring about an effect identical to that brought about in a case where the light absorbing section 5 is formed by accumulating the convex parts each having the round edge, even in a case where the light absorbing section 5 is formed by accumulating the convex parts each having the quadrangular cross section.

The light absorbing section 5 is thus formed by accumulating the convex parts each having the cross section whose aspect ratio is approximately 1 (one). However, the light absorbing section 5 to be formed is not necessarily limited to this. Alternatively, as shown in, for example, (c) of FIG. 11, the light absorbing section 5 can be formed by accumulating convex parts each having a cross section whose aspect ratio is not less than 1 (one) provided that such convex parts can be printed several times to be accumulated.

(Example of the Shape of the Light Diffusing Section 4)

As early described, the upper and lower base films are possibly misalignedly adhered to each other. In order to prevent such misalignment, the wall surface of the concave part 8 of the light diffusing section 4 can be a convexoconcave surface. The following description will discuss an example of the shape of the light diffusing section 4 with reference to FIG. 12. (a) of FIG. 12 is a view showing a cross section of a concave part 8 of a light diffusing section 4, which concave part 8 has a convexoconcave wall surface. (b) of FIG. 12 is a view showing a cross section of a concave part 8 internally having a light absorbing section 5 having a convexoconcave inclined surface.

The convexoconcave wall surface of the concave part 8 of the light diffusing section 4 can be formed by coarsely shaving the wall surface of the concave part 8 in forming the concave part 8 of the light diffusing section 4 by a cutting method. Alternatively, the convexoconcave wall surface of the concave part 8 of the light diffusing section 4 can be formed by shaving the wall surface of the concave part 8 by use of a metal having a predetermined convexoconcave edge. This allows the concave part 8 to have the convexoconcave wall surface. Alternatively, the convexoconcave wall surface of the concave part 8 of the light diffusing section 4 can be formed by applying and attaching spacers, such as silica spheres, onto a smooth wall surface of a concave part 8. The convexoconcave wall surface of the concave part 8 of the light diffusing section 4 thus formed has convex parts that are in contact with an inclined surface of a light absorbing section 5 (see (a) of FIG. 12). In a case where each of the convex parts has a round or triangular cross section, it is possible to reduce as much as possible a surface area of the convex parts which come into contact with the light absorbing section 5. According to the configuration, the convex parts of the convexoconcave wall surface of the concave part 8 hold the light absorbing section 5 even in a case where the upper and lower base films are misalignedly adhered to each other. It is therefore possible to prevent the inclined surface of the light absorbing section 5 from coming into contact with the wall surface of the concave part 8. Though a part (the convex parts) of the wall surface of the concave part 8 is actually in contact with the light absorbing section 5, the convex parts have a small surface area that comes into contact with the light absorbing section 5. Therefore, a visual perceived display property of a display device is hardly decreased by absorption of light that has entered the convex parts.

The convex parts of the wall surface of the concave part 8 of the light diffusing section 4 thus holds the light absorbing section 5. Therefore, there is a gap between the light absorbing section 5 and the concave part 8. The gap has a refractive index greatly different from that of the light diffusing section 4. It is therefore possible to increase, by approximately 80%, a utilization efficiency of light that enters at angles of not less than 10° or not more than −10° to the direction perpendicular to the light diffusion sheet 1. This consequently allows a whole light utilization efficiency to be increased by approximately 30%. It is thus possible to attain a sufficient light diffusivity even in a case where the part of the wall surface of the light diffusing section 4 is in contact with the light absorbing section 5.

The above description discussed a case where the concave part 8 of the light diffusing section 4 has the convexoconcave wall surface. Alternatively, the light absorbing section 5 can have a convexoconcave inclined surface, as shown in (b) of FIG. 12. The convexoconcave inclined surface can be formed to have convex parts each having a round or triangular cross section. In this case, it is possible to reduce as much as possible a surface area of the light absorbing section 5 which comes into contact with the wall surface of the concave part 8 of the light diffusing section 4. According to the configuration, the convex parts of the convexoconcave inclined surface of the light absorbing section 5 holds the wall surface of the concave part 8 even in a case where the upper and lower base films are misalignedly adhered to each other. It is therefore possible to bring about an effect identical to that brought about in the case where the concave part 8 has the convexoconcave wall surface, even in the case where the light absorbing section 5 has the convexoconcave inclined surface.

### Summary of Embodiment

The light diffusion sheet of the present invention is configured such that the gap is formed between a whole wall surface of the concave part and the light absorbing section.

According to the configuration, it is possible to prevent a decrease in light utilization efficiency caused by contact of the light absorbing section with the wall surface of the concave part of the light diffusing section.

The light diffusion sheet of the present invention is configured such that the light absorbing section extends to a vicinity of a deepest part of the concave part.

According to the configuration, it is possible to absorb light, such as stray light, which has entered the vicinity of the deepest part of the concave part of the light diffusing section.

The light diffusion sheet of the present invention is configured such that the concave part has a substantially V-shaped cross section that tapers toward the light entering surface, the cross section being taken along a thickness direction of the light diffusing section.

According to the configuration, it is possible to (i) radially diffuse incident light, (ii) efficiently diffuse light by use of a single light diffusion sheet and (iii) attain a wide viewing angle.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a light diffusion sheet, for use in a display device such as a liquid crystal display device, for increasing a viewing angle of the display device.

### REFERENCE SIGNS LIST

1: light diffusion sheet
2: lower base film
3: upper base film
4: light diffusing section
5: light absorbing section
6: adhesive layer
7: liquid crystal panel
8: concave part
9: backlight
10: transmissive display device
14a and 14b: polarizing plate
15a and 15b: phase plate
16a and 16b: glass plate
17: color filter
18: liquid crystal layer

1. A light diffusion sheet, comprising:
a light diffusing section for diffusing light that has entered therein from a light entering surface so as to emit the diffused light from a light emitting surface, in which light diffusing section a plurality of concave parts each having a wall surface that transmits the light or totally reflects the light are formed;
a support film provided on the light emitting surface of the light diffusing section; and
a plurality of light absorbing sections supported by the support film, the plurality of light absorbing sections being provided independently in at least one of the plurality of respective concave parts,
a gap being formed in at least one of the plurality of respective concave parts such that the gap is formed between (i) a part of a wall surface of each concave part, which part is in a vicinity of an opening of the concave part and (ii) the light absorbing section provided in the concave part.

2. The light diffusion sheet as set forth in claim 1, wherein the gap is formed between a whole wall surface of the concave part and the light absorbing section.

3. The light diffusion sheet as set forth in claim 1, wherein the light absorbing section extends to a vicinity of a deepest part of the concave part.

4. The light diffusion sheet as set forth in claim 1, wherein
the concave part has a substantially V-shaped cross section that tapers toward the light entering surface, the cross section being taken along a thickness direction of the light diffusing section.

5. A transmissive display device, comprising a light diffusion sheet recited in claim 1.

6. A method for manufacturing a light diffusion sheet that includes a light diffusing section for diffusing light that has entered from a light entering surface so as to emit the diffused light from a light emitting surface,
the method comprising the steps of:
forming the light diffusing section on a lower base film;
forming a plurality of concave parts in a surface of the light diffusing section, which surface is opposite to a surface that is in contact with the lower base film;
forming a plurality of light absorbing sections on an upper base film; and
adhering the light diffusing section and the upper base film to each other such that the plurality of light absorbing sections formed on the upper base film fit in the plurality of respective concave parts formed in the surface of the light diffusing section,
the light diffusing section and the upper base film being adhered to each other such that a gap is formed between (i) a part of a wall surface of each of the plurality of concave parts, which part is in a vicinity of an opening of the concave part and (ii) the light absorbing section provided in the concave part.

7. The method as set forth in claim 6, further comprising the step of removing the lower base film from the light diffusing section adhered to the upper base film.
